(19) United States
(12) Patent Application Publication
(10) Pub. No.: US 2026/0295531 A1
(43) Pub. Date: Oct. 1, 2026

(54) DAC APPARATUS

(71) Applicant: Honda Motor Co., Ltd., Tokyo (JP)

(72) Inventors: Hiroka Shigi, Saitama (JP); Hibiki Kimura, Saitama (JP)

(21) Appl. No.: 19/577,330

(22) Filed: Mar. 24, 2026

(30) Foreign Application Priority Data
Mar. 28, 2025 (JP) 2025-055215

(51) Int. Cl. B01D 53/96; B01D 53/34; B01D 53/62; B01D 53/82

(52) U.S. Cl. CPC B01D 53/96; B01D 53/346; B01D 53/62; B01D 53/82; B01D 2253/20; B01D 2257/504; B01D 2258/06; B01D 2259/40088

(57) ABSTRACT

A DAC apparatus to recover CO₂ in atmosphere, includes: a heat pump to transfer heat from a low-temperature heat medium to a high-temperature heat medium to raise the temperature of the high-temperature heat medium to a target temperature, the low-temperature heat medium cooling an adsorbent for adsorbing or absorbing CO₂, the high-temperature heat medium heating the adsorbent; a high-temperature-side heat exchanger provided on a high-temperature-side flow passage through which the high-temperature heat medium flows and configured to cool the high-temperature heat medium through heat exchange with outside air; a high-temperature-side control valve provided on the high-temperature-side flow passage and configured to switch whether to pass through or bypass the high-temperature-side heat exchanger; and a controller to control the high-temperature-side control valve to pass through the high-temperature-side heat exchanger when the temperature of the low-temperature heat medium is equal to or higher than a predetermined temperature.

### CROSS-REFERENCE TO RELATED APPLICATION

This application is based upon and claims the benefit of priority from Japanese Patent Application No. 2025-055215 filed on Mar. 28, 2025, the content of which is incorporated herein by reference.

### BACKGROUND OF THE INVENTION

### Field of the Invention

The present invention relates to a direct air capture (DAC) apparatus that recovers carbon dioxide (CO₂) in the atmosphere.

### Description of the Related Art

For the purpose of mitigating climate changes, research and development have been conducted on DAC technology for recovering CO₂, which is a main greenhouse gas. As such a DAC technology, a DAC apparatus that recovers CO₂ in the atmosphere using an adsorbent for adsorbing or absorbing CO₂ is known. For example, in the DAC apparatus of WO 2024/013957 A1, after outside air is introduced to adsorb CO₂ in the air to the adsorbent, the adsorbent is heated by the regenerated fluid heated by a heat pump unit to desorb CO₂ from the adsorbent, and the regenerated discharge fluid containing CO₂ that has been desorbed from the adsorbent is cooled by the regenerated fluid that has been cooled by the heat pump unit to liquefy and separate CO₂ from the regenerated discharge fluid.

However, in a case where each part is cooled using the heat pump as in the DAC apparatus described in WO 2024/013957 A1, when the outside air temperature is high, it may be difficult to appropriately cool each part.

### SUMMARY OF THE INVENTION

An aspect of the present invention is a DAC apparatus configured to recover CO₂ in the atmosphere, including: a heat pump configured to transfer heat from low-temperature heat medium to high-temperature heat medium to raise a temperature of the high-temperature heat medium to a target temperature, the low-temperature heat medium cooling an adsorbent for adsorbing or absorbing CO₂, the high-temperature heat medium heating the adsorbent; a high-temperature-side heat exchanger provided on a high-temperature-side flow passage through which the high-temperature heat medium flows and configured to cool the high-temperature heat medium through heat exchange with outside air; a high-temperature-side control valve provided on the high-temperature-side flow passage and configured to switch whether to pass through or bypass the high-temperature-side heat exchanger; and a controller configured to control the high-temperature-side control valve. The controller controls the high-temperature-side control valve to pass through the high-temperature-side heat exchanger when a temperature of the low-temperature heat medium is equal to or higher than a predetermined temperature.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of a configuration of gas piping of a DAC apparatus according to an embodiment of the present invention;

FIG. 2 is a block diagram schematically illustrating an example of a configuration of heat medium piping of the DAC apparatus according to the embodiment of the present invention;

FIG. 3 is a block diagram schematically illustrating an example of a piping configuration between a heat pump and a high-temperature water tank and a low-temperature water tank shown in FIG. 2;

FIG. 4 is a block diagram schematically illustrating an example of a control configuration of the DAC apparatus according to the embodiment of the present invention; and

FIG. 5 is a diagram for describing switching between flow passages passing through heat dissipation portions and a bypass flow passages shown in FIG. 3.

### DETAILED DESCRIPTION OF THE INVENTION

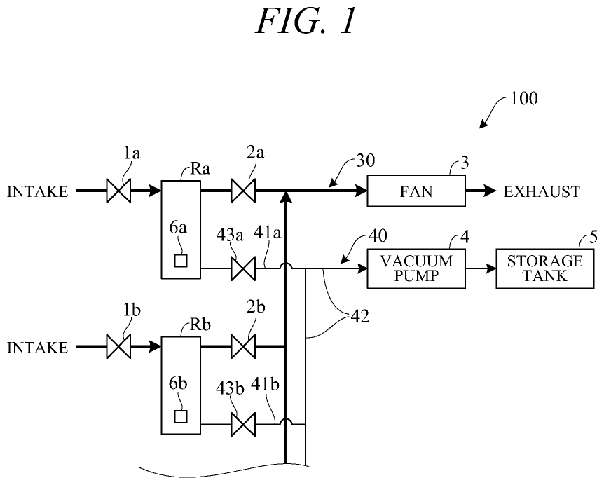

Hereinafter, embodiments of the present invention will be described with reference to FIGS. 1 to 5. FIG. 1 is a block diagram schematically illustrating an example of a configuration of gas piping of a DAC apparatus 100 according to an embodiment of the present invention. As illustrated in FIG. 1, the DAC apparatus 100 mainly includes a plurality of reactors R (Ra, Rb, and so on) in each of which an adsorbent for adsorbing or absorbing CO₂ is provided.

The reactor R includes a housing in which a sealed space (an adsorption chamber) can be formed, and an adsorbent is provided in the adsorption chamber of the reactor R. As the adsorbent, a solid material composed to adsorb CO₂ at normal temperature and normal pressure and to desorb CO₂ as the temperature rises can be used. For example, an amine-based solid absorbent in which an amine-based compound is carried on an appropriate carrier can be used. The adsorbent is constituted in an appropriate granular shape, is filled in a filter cartridge or the like having a mesh structure, for example, and is accommodated in the adsorption chamber of the reactor R.

Control valves 1 (1a, 1b, and so on) and 2 (2a, 2b, and so on), which open the reactor R to the atmosphere or seal the reactor R from the atmosphere, are provided for the reactor R. The control valves 1 and 2 may be provided on piping that connects the adsorption chamber of the reactor R with an external space, or may be provided as a part of a housing (a wall surface) of the reactor R. When the control valves 1 and 2 are opened, the adsorption chamber of the reactor R is opened to the atmosphere. When the control valves 1 and 2 are closed, the adsorption chamber of the reactor R is sealed. The control valve 1 and the control valve 2 are provided to face each other with the adsorption chamber interposed between them.

A fan 3 for circulating the atmosphere into the adsorption chamber of the reactor R is connected with the reactor R through appropriate piping (atmospheric piping) 30 and one of the control valves 1 and 2 (the control valve 2 in the illustrated example). In the illustrated example, when the control valves 1 and 2 are open and the fan 3 is driven, the atmosphere is taken into the reactor R through the control valve 1, and the atmosphere is exhausted from the reactor R through the control valve 2, the atmospheric piping 30, and the fan 3. Thus, when the atmosphere circulates into the reactor R, CO₂ in the atmosphere is adsorbed to the adsorbent in the adsorption chamber (an adsorption step). The control valves 1 and 2 and the atmospheric piping 30 are each configured to have a relatively large diameter so as to enable a large amount of atmosphere to circulate into the reactor R. A plurality of control valves 1 and a plurality of control valves 2 may be provided.

Vacuum piping 40 is further connected with the reactor R. The vacuum piping 40 connects the adsorption chamber of the reactor R with an intake port of a vacuum pump 4. More specifically, the vacuum piping 40 includes: individual piping 41 (41a, 41b, and so on), which communicates with the adsorption chamber of each reactor R; and junction piping 42, which joins the individual piping 41 to communicate with the intake port of the vacuum pump 4, and thus connects the individual piping 41 with the vacuum pump 4.

On each individual piping 41, a control valve 43 (43a, 43b, and so on), which permits or prohibits the flow of gas in the individual piping 41, that is, the flow from the reactor R to the vacuum piping 40, is provided. The control valve 43 may be made up of an on-off valve such as a ball valve, may be made up of an adjustment valve such as a butterfly valve, or may be made up of a combination of them. A storage tank 5 is connected with an exhaust port of the vacuum pump 4 through appropriate piping. The control valve 43 is closed in an adsorption step.

In the reactor R, a heat exchanger 6 (6a, 6b, and so on), which heats or cools the adsorbent, is provided. A high-temperature heat medium having a high temperature (for example, water having a high temperature (high-temperature water)) and a low-temperature heat medium having normal temperature (for example, water having a low temperature (low-temperature water)) in accordance with a desorption temperature of CO₂ are supplied to the heat exchanger 6. The heat exchanger 6 heats the adsorbent when the high-temperature water is supplied, and cools the adsorbent when the low-temperature water is supplied.

When the control valves 1 and 2 are closed, the control valve 43 is opened, and the vacuum pump 4 is driven, the gas in the adsorption chamber of the reactor R is sucked out by the vacuum pump 4 through the vacuum piping 40. Furthermore, when the adsorbent in the adsorption chamber is heated by the heat exchanger 6, CO₂ that has been adsorbed to the adsorbent in the reactor R is desorbed. The desorption gas mainly containing the desorbed CO₂ is sucked out of the reactor R, is stored in the storage tank 5, and is recovered (a desorption step).

After the desorption step ends and before the adsorption step starts, the control valves 1 and 2 and the control valve 43 are closed, and the adsorbent in the adsorption chamber is cooled by the heat exchanger 6 (a cooling step).

In the DAC apparatus 100, the adsorption step, the desorption step, and the cooling step are sequentially performed in the plurality of reactors R by shifting the timing.

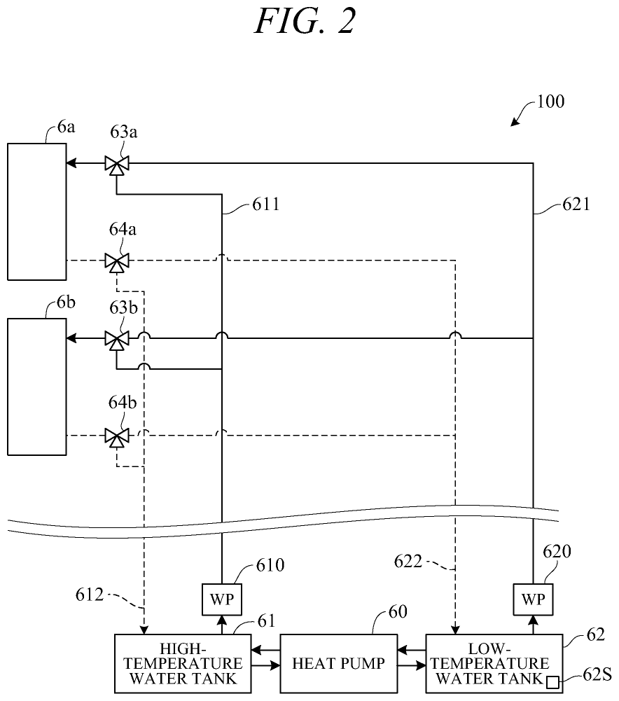

FIG. 2 is a block diagram schematically illustrating an example of a configuration of heat medium piping of the DAC apparatus 100. As illustrated in FIG. 2, in the DAC apparatus 100, a heat pump 60 for supplying high-temperature water and low-temperature water to the heat exchanger 6, which is provided in each reactor R, is provided.

The heat pump 60 includes: an evaporator (a heat exchanger) that evaporates a working fluid; a compressor that compresses the evaporated working fluid; a condenser (a heat exchanger) that condenses the compressed working fluid; and an expansion valve that expands the condensed working medium, and the heat pump 60 transfers heat of low-temperature water to high-temperature water. In the evaporator, the heat of the low-temperature water is absorbed by the working fluid, and the working fluid is evaporated (vaporized) (an evaporation step). In the compressor, a gaseous working fluid is brought into a high-temperature and high-pressure state through adiabatic compression (a compression step). In the condenser, heat of the gaseous working fluid is dissipated to the high-temperature water, and the working fluid is condensed (liquefied) (a condensation step). In the expansion valve, a liquid working fluid is brought into a low-temperature and low-pressure state through adiabatic expansion (an expansion step). The heat pump 60 circulates the working fluid between the low-temperature water and the high-temperature water, and repeats the evaporation step, the compression step, the condensation step, and the expansion step to transfer the heat of the low-temperature water to the high-temperature water.

In the heat pump 60, the rotation speed of the compressor is adjusted in such a manner that the temperature of the high-temperature water is raised to a target temperature set beforehand in accordance with a desorption temperature (for example, approximately 100 degrees Celsius) of CO₂. That is, the rotation speed of the compressor is adjusted in such a manner that the temperature of the high-temperature water coming out of the heat pump 60 becomes a target temperature in accordance with the temperature of the high-temperature water entering the heat pump 60. In the heat pump 60, the heat absorbed from the low-temperature water by the evaporator is dissipated to the high-temperature water by the condenser, and thus the temperature of the high-temperature water increases. Therefore, as the temperature rise width of the high-temperature water increases, the temperature drop width of the low-temperature water increases. As the rotation speed of the compressor increases and the load (power consumption) of the heat pump 60 increases, the temperature rise width of the high-temperature water and the temperature drop width of the low-temperature water increase.

A high-temperature water tank 61, which stores high-temperature water to be circulated to the condenser of the heat pump 60, and a low-temperature water tank 62, which stores low-temperature water to be circulated to the evaporator of the heat pump 60, are connected with the heat pump 60 through appropriate piping. In a low-temperature water tank 62, a water temperature sensor 62S, which detects a temperature T of the low-temperature water (a temperature of low-temperature water), is provided.

The high-temperature water tank 61 and the low-temperature water tank 62 are further connected with the heat exchanger 6 of each reactor R through appropriate piping, and the high-temperature water stored in the high-temperature water tank 61 and the low-temperature water stored in the low-temperature water tank 62 are circulated to the heat exchanger 6 of each reactor R through piping.

More specifically, the high-temperature water stored in the high-temperature water tank 61 flows through a flow passage 611, on which a water supply pump 610 is provided, at a flow rate corresponding to the rotation speed of the water supply pump 610, and is supplied to the heat exchanger 6 of each reactor R. After the adsorbent of each reactor R is heated, the high-temperature water discharged from the heat exchanger 6 flows through a flow passage 612, and returns to the high-temperature water tank 61.

Similarly, the low-temperature water stored in the low-temperature water tank 62 flows through a flow passage 621, on which a water supply pump 620 is provided, at a flow rate corresponding to the rotation speed of the water supply pump 620, and is supplied to the heat exchanger 6 of each reactor R. After the adsorbent of each reactor R is cooled, the low-temperature water discharged from the heat exchanger 6 flows through a flow passage 622, and returns to the low-temperature water tank 62.

A control valve (a three-way valve) 63 (63a, 63b, and so on), which switches whether to supply the high-temperature water from the flow passage 611 or to supply the low-temperature water from the flow passage 621 as a heat medium flowing through the heat exchanger 6, is provided at an inlet of the heat exchanger 6 of each reactor R. A control valve (a three-way valve) 64 (64a, 64b, and so on), which switches whether to return the heat medium that has been discharged from the heat exchanger 6 to the flow passage 612 or to return the heat medium to the flow passage 622, is provided at an outlet of the heat exchanger 6 of each reactor R. The control valves 63 and 64 are respectively controlled in such a manner that the high-temperature water is circulated through the flow passages 611 and 612 to the heat exchanger 6 of the reactor R in the desorption step and the low-temperature water is circulated through the flow passages 621 and 622 to the heat exchanger 6 of the reactor R in the cooling step.

In this manner, with regard to the temperatures of the high-temperature water and the low-temperature water circulated to the heat exchanger 6 of the reactor R, into which the atmosphere circulates, so as to exchange heat with the adsorbent, the temperatures increase as the outside air temperature increases. In this case, the load of the heat pump 60, which raises the temperature of the high-temperature water to the target temperature, decreases, and the temperature drop width of the low-temperature water in the heat pump 60 decreases. Hence, the temperature T of the low-temperature water is continuously rising, and it may be difficult to appropriately cool each unit of the DAC apparatus 100 including the adsorbent. Therefore, in the present embodiment, the DAC apparatus 100 is configured as follows in such a manner that the temperature T of the low-temperature water is lowered so that each unit of the apparatus can be appropriately cooled.

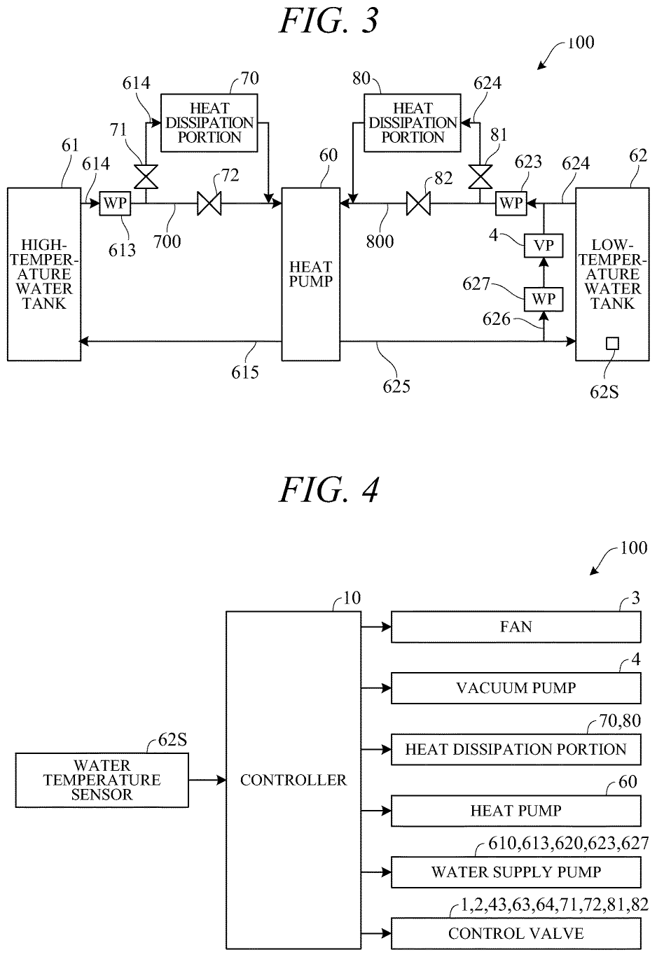

FIG. 3 is a block diagram schematically illustrating an example of a piping configuration between the heat pump 60 and the high-temperature water tank 61 and the low-temperature water tank 62 shown in FIG. 2. As illustrated in FIG. 3, the high-temperature water stored in the high-temperature water tank 61 flows through a flow passage 614, on which a water supply pump 613 is provided, at a flow rate corresponding to the rotation speed of the water supply pump 613, enters the condenser of the heat pump 60, and is heated to a target temperature by heat dissipation from a working fluid. The high-temperature water that has been heated to the target temperature by the heat pump 60 flows through a flow passage 615, and returns to the high-temperature water tank 61.

Similarly, the low-temperature water stored in the low-temperature water tank 62 flows through a flow passage 624, on which a water supply pump 623 is provided, at a flow rate corresponding to the rotation speed of the water supply pump 623, enters the evaporator of the heat pump 60, and is cooled by heat absorption to the working fluid. The low-temperature water that has been cooled by the heat pump 60 flows through a flow passage 625, and returns to the low-temperature water tank 62.

A heat dissipation portion 70, which dissipates the heat of the high-temperature water flowing through the flow passage 614, is provided on the flow passage 614 from the high-temperature water tank 61 to the heat pump 60, and a heat dissipation portion 80, which dissipates the heat of the low-temperature water flowing through the flow passage 624, is provided on the flow passage 624 from the low-temperature water tank 62 to the heat pump 60. The heat dissipation portions 70 and 80 each include: a heat exchanger through which the high-temperature water or the low-temperature water flows; and a fan for air-cooling such a heat exchanger. By promoting heat exchange between the high-temperature water or the low-temperature water and the outside air, the heat dissipation portions 70 and 80 respectively cool the high-temperature water or the low-temperature water. In the heat dissipation portion 70, the high-temperature water before being heated by the heat pump 60 is cooled. In the heat dissipation portion 80, the low-temperature water before being cooled by the heat pump 60 is cooled.

A bypass flow passage 700, which bypasses the heat dissipation portion 70, is connected with the flow passage 614. A control valve (an on-off valve) 71, which permits or prohibits the flow of the high-temperature water to pass through the heat dissipation portion 70, is provided on the flow passage 614, which is disposed downstream a branch point where the bypass flow passage 700 branches from the flow passage 614, and which is disposed upstream the heat dissipation portion 70. In addition, on the bypass flow passage 700, a control valve (an on-off valve) 72, which permits or prohibits the flow of the high-temperature water to pass through the bypass flow passage 700, is provided. With the control valves 71 and 72, it is possible to switch whether to pass through or bypass the heat dissipation portion 70. That is, when the control valve 71 is open and the control valve 72 is closed, the high-temperature water from the high-temperature water tank 61 flows through the heat dissipation portion 70. When the control valve 71 is closed and the control valve 72 is open, the high-temperature water from the high-temperature water tank 61 bypasses the heat dissipation portion 70. Instead of the control valves (the on-off valves) 71 and 72, a control valve (a three-way valve) may be provided at the branch point where the bypass flow passage 700 branches from the flow passage 614.

A bypass flow passage 800, which bypasses the heat dissipation portion 80, is connected with the flow passage 624. A control valve (an on-off valve) 81, which permits or prohibits the flow of the low-temperature water to pass through the heat dissipation portion 80, is provided on the flow passage 624, which is disposed downstream a branch point where the bypass flow passage 800 branches from the flow passage 624, and which is disposed upstream the heat dissipation portion 80. In addition, on the bypass flow passage 800, a control valve (an on-off valve) 82, which permits or prohibits the flow of the low-temperature water to pass through the bypass flow passage 800, is provided. With the control valves 81 and 82, it is possible to switch whether to pass through or bypass the heat dissipation portion 80. That is, when the control valve 81 is open and the control valve 82 is closed, the low-temperature water from the low-temperature water tank 62 flows to the heat dissipation portion 80. When the control valve 81 is closed and the control valve 82 is open, the low-temperature water from the low-temperature water tank 62 bypasses the heat dissipation portion 80. Instead of the control valves (the on-off valves) 81 and 82, a control valve (a three-way valve) may be provided at the branch point where the bypass flow passage 800 branches from the flow passage 624.

The flow passage 624 through which the low-temperature water flows and the flow passage 625 are connected by a branch flow passage 626. More specifically, the branch flow passage 626 connects the flow passage 625, which is disposed from the heat pump 60 to the low-temperature water tank 62, with the flow passage 624, which is disposed from the low-temperature water tank 62 to the water supply pump 623, and guides some amount of the low-temperature water flowing through the flow passage 625 to the flow passage 624, which is disposed upstream the heat dissipation portion 80. A water supply pump 627 is provided on the branch flow passage 626, and some amount of the low-temperature water flowing through the flow passage 625 flows through the branch flow passage 626 at a flow rate corresponding to the rotation speed of the water supply pump 627. The branch flow passage 626, which is disposed downstream the water supply pump 627, is provided in close contact with the vacuum pump 4, and the vacuum pump 4 is cooled by the low-temperature water flowing through the branch flow passage 626, which is disposed downstream the water supply pump 627. Thus, the vacuum pump 4 is cooled by the low-temperature water that has been cooled by the heat pump 60.

The low-temperature water having the temperature that has been increased by cooling the vacuum pump 4 is sucked into the water supply pump 623, enters the flow passage 624 from the branch flow passage 626, is merged with the low-temperature water flowing from the low-temperature water tank 62 to the heat pump 60, flows through the heat dissipation portion 80, and enters the heat pump 60. In the heat dissipation portion 80, the low-temperature water flowing through the flow passage 624, which is disposed downstream a connection portion with the branch flow passage 626, is cooled. That is, the low-temperature water cools the adsorbent of each reactor R and the vacuum pump 4, and the temperature of the low-temperature water rises. Then, the low-temperature water is cooled before being cooled by the heat pump 60.

FIG. 4 is a block diagram schematically illustrating an example of a control configuration of the DAC apparatus 100. As illustrated in FIG. 4, the DAC apparatus 100 includes a controller 10, which controls each unit of the DAC apparatus 100 including the fan 3, the vacuum pump 4, the heat pump 60, the heat dissipation portions 70 and 80, the water supply pumps 610, 613, 620, 623, and 627, and the control valves 1, 2, 43, 63, 64, 71, 72, 81, and 82 of FIGS. 1 to 3. The controller 10 is made up of a computer including a CPU, a ROM, a RAM, an I/O interface, and other peripheral circuits. The water temperature sensor 62S in FIG. 3 is connected with the controller 10, and a signal indicating a detection value of the water temperature sensor 62S is input into the controller 10.

When the DAC apparatus 100 is activated, the controller 10 controls the control valves 1, 2, 43, 63, 64, 71, 72, 81, and 82 while driving the fan 3, the vacuum pump 4, the heat pump 60, and the water supply pumps 610, 613, 620, 623, and 627. More specifically, the control valves 1, 2, 43, 63, and 64 are controlled in such a manner that the adsorption step, the desorption step, and the cooling step are sequentially performed in the plurality of reactors R by shifting the timing. In addition, the controller 10 controls the control valves 71 and 72, which switch whether the high-temperature water passes through the heat dissipation portion 70 or bypasses the heat dissipation portion 70, and the control valves 81 and 82, which switch whether the low-temperature water passes through the heat dissipation portion 80 or bypasses the heat dissipation portion 80, based on the temperature T of the low-temperature water that has been detected by the water temperature sensor 62S.

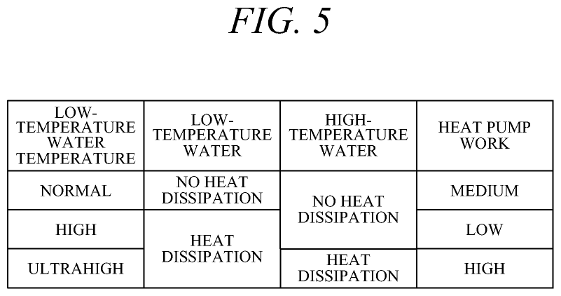

FIG. 5 is a diagram for describing switching between the flow passages 614 and 624, which respectively pass through the heat dissipation portions 70 and 80, and the bypass flow passages 700 and 800 shown in FIG. 3. As illustrated in FIG. 5, the controller 10 controls the control valves 71, 72, 81, and 82, based on the temperature T of the low-temperature water that has been detected by the water temperature sensor 62S, and switches between the flow passages 614 and 624, which respectively pass through the heat dissipation portions 70 and 80, and the bypass flow passages 700 and 800.

More specifically, in a normal temperature range in which the temperature T of the low-temperature water is lower than a first temperature T1, the control valves 71 and 81 are controlled to be closed and the control valves 72 and 82 are controlled to be opened so as to switch to the bypass flow passages 700 and 800, which respectively bypass the heat dissipation portions 70 and 80. In this case, the low-temperature water is sufficiently cooled by the rated operation of the heat pump 60, and thus the heat dissipation portions 70 and 80 (fans) are not driven, and no power is consumed in the heat dissipation portion 70 or 80.

In a high-temperature range in which the temperature T of the low-temperature water is equal to or higher than the first temperature T1 and is lower than a second temperature T2, the control valve 71 is controlled to be closed and the control valve 72 is controlled to be opened so as to switch to the bypass flow passage 700, which bypasses the heat dissipation portion 70. In addition, the control valve 81 is controlled to be opened and the control valve 82 is controlled to be closed so as to switch to the flow passage 624, which passes through the heat dissipation portion 80, and in addition, the heat dissipation portion 80 (the fan) is driven. In this case, the low-temperature water cools the adsorbent of each reactor R and the vacuum pump 4, and the temperature of the low-temperature water rises. Then, excessive heat is dissipated from the low-temperature water in the heat dissipation portion 80 before the low-temperature water is cooled by the heat pump 60, and thus the temperature of the low-temperature water entering the heat pump 60 is lowered. In the high-temperature range, the outside air temperature is high and the temperature of the high-temperature water (the temperature of the high-temperature water) is also high, the load of the heat pump 60 (the compressor), which raises the temperature of the high-temperature water to the target temperature, decreases. In this case, the temperature rise width of the high-temperature water and the temperature drop width of the low-temperature water also decrease. However, by lowering the temperature of the low-temperature water entering the heat pump 60, it becomes possible to sufficiently lower the temperature of the low-temperature water coming out of the heat pump 60.

In an ultrahigh-temperature range where the temperature T of the low-temperature water is equal to or higher than the second temperature T2, the control valves 71 and 81 are controlled to be opened and the control valves 72 and 82 are controlled to be closed so as to switch to the flow passages 614 and 624, which respectively pass through the heat dissipation portions 70 and 80, and in addition, the heat dissipation portions 70 and 80 (the fans) are driven. In this case, in a similar manner to the high-temperature range, the low-temperature water is cooled by the heat dissipation portion 80, and the high-temperature water is cooled by the heat dissipation portion 70, and the temperature of the high-temperature water entering the heat pump 60 is lowered. When the temperature of the high-temperature water entering the heat pump 60 is lowered, the temperature rise width to the target temperature increases, the load of the heat pump 60 (the compressor) increases, and the power consumption increases. However, the temperature drop width of the low-temperature water also increases, and thus it becomes possible to sufficiently lower the temperature of low-temperature water.

In this manner, by cooling the low-temperature water in the heat dissipation portion 80 and cooling the high-temperature water in the heat dissipation portion 70 in accordance with the temperature T of the low-temperature water, it becomes possible to sufficiently lower the temperature of the low-temperature water coming out of the heat pump 60, and to sufficiently cool the adsorbent of each reactor R and the vacuum pump 4 using the low-temperature water. Thus, also under the condition where the outside air temperature is high and the temperatures of the high-temperature water and the low-temperature water are high, the temperature T of the low-temperature water is maintained in an appropriate temperature range, and each unit of the DAC apparatus 100 is appropriately cooled, so that the stable operation can be continuously performed.

The controller 10 controls each unit to stop the operation of the DAC apparatus 100 in an abnormal temperature range where the temperature T of the low-temperature water is equal to or higher than a third temperature T3, which is higher than the second temperature T2. That is, even though the low-temperature water is cooled by the heat dissipation portion 80 and the high-temperature water is cooled by the heat dissipation portion 70, in a case where the temperature T of the low-temperature water rises to such an extent that the temperature of the low-temperature water coming out of the heat pump 60 cannot be lowered to an appropriate temperature range, all operations accompanied with heating of the adsorbent are stopped. When the temperature of the adsorbent becomes high in a state in which oxygen is present in the adsorption chamber, the adsorbent may be subject to oxidation deterioration. In order to continue the operation of the DAC apparatus 100, it is necessary to deaerate the residual atmosphere containing oxygen from the adsorption chamber of the reactor R by the vacuum pump 4 before the adsorbent is heated in the desorption step, and to cool the adsorbent with low-temperature water through the heat exchanger 6 before the atmosphere is circulated into the adsorption chamber in the adsorption step. In the abnormal temperature range where the temperature T of the low-temperature water is equal to or higher than the third temperature T3, the oxidation deterioration of the adsorbent can be prevented by stopping the operation of the DAC apparatus 100. In this case, after the outside air temperature decreases, the sound operation of the DAC apparatus 100 can be resumed.

According to the embodiments of the present invention, the following operation and effects are achievable.

(1) The DAC apparatus 100 includes: the heat pump 60, which transfers heat from the low-temperature water to the high-temperature water to raise the temperature of the high-temperature water to a target temperature, the low-temperature water cooling an adsorbent for adsorbing or absorbing CO₂, the high-temperature water heating the adsorbent; the heat dissipation portion 70, which is provided on the flow passage 614 through which the high-temperature water flows, and which cools the high-temperature water through heat exchange with outside air; the control valves 71 and 72, which are provided on the flow passage 614, and which switch whether to pass through or bypass the heat dissipation portion 70, and the controller 10 configured to control the control valves 71 and 72 (FIGS. 1 to 4). When the temperature T of the low-temperature water is equal to or higher than the second temperature T2, the controller 10 controls the control valves 71 and 72 to cause the high-temperature water to pass through the heat dissipation portion 70 (FIG. 5).

In this manner, by cooling the high-temperature water in the heat dissipation portion 70 to lower the temperature of the high-temperature water entering the heat pump 60, it becomes possible to increase the temperature rise width to the target temperature set beforehand in accordance with the desorption temperature of CO₂, and to increase the load of heat pump 60, so that the temperature of the low-temperature water can be significantly lowered. Thus, also under the condition where the outside air temperature is high and the temperatures of the high-temperature water and the low-temperature water are high, the temperature T of the low-temperature water is maintained in an appropriate temperature range, and each unit of the DAC apparatus 100 is appropriately cooled, so that the stable operation can be continuously performed.

(2) The DAC apparatus 100 further includes: the heat dissipation portion 80, which is provided on the flow passage 624 through which the low-temperature water flows, and which cools the low-temperature water through heat exchange with the outside air; and the control valves 81 and 82, which are provided on the flow passage 624, and which switch whether to pass through or bypass the heat dissipation portion 80 (FIG. 3). The controller 10 further controls the control valves 71, 72, 81, and 82 to bypass the heat dissipation portions 70 and 80 when the temperature T of the low-temperature water is lower than the first temperature T1, to pass the heat dissipation portion 80 and bypass the heat dissipation portion 70 when the temperature T of the low-temperature water is equal to or higher than the first temperature T1 and is lower than the second temperature T2, and to pass the heat dissipation portions 70 and 80 when the temperature T of the low-temperature water is equal to or higher than the second temperature T2 (FIG. 5). Thus, the low-temperature water is cooled in the heat dissipation portion 80 and the high-temperature water is cooled in the heat dissipation portion 70 in accordance with the temperature T of the low-temperature water, and the temperature of the low-temperature water coming out of the heat pump 60 is sufficiently lowered, so that each unit of the DAC apparatus 100 including the adsorbent can be sufficiently cooled by the low-temperature water.

(3) The controller 10 further stops the operation of the DAC apparatus 100 when the temperature T of the low-temperature water is equal to or higher than the third temperature T3, which is higher than the second temperature T2. In the abnormal temperature range in which the temperature T of the low-temperature water rises to such an extent that the temperature cannot be lowered to an appropriate temperature range even though the low-temperature water is cooled in the heat dissipation portion 80 and the high-temperature water is cooled in the heat dissipation portion 70, the operation of the DAC apparatus 100 is stopped, so that the oxidation deterioration of the adsorbent can be prevented.

(4) The DAC apparatus 100 further includes the vacuum pump 4, which is connected through the vacuum piping 40 with the reactor R in which the adsorbent is provided, and which sucks the desorption gas from the adsorbent (FIG. 1). The low-temperature water further cools the vacuum pump 4 (FIG. 3). The DAC apparatus 100 further includes: the high-temperature water tank 61, which stores the high-temperature water; and the low-temperature water tank, which stores the low-temperature water (FIGS. 2 and 3).

The flow passages through which the high-temperature water flows include: the flow passage 615, through which the high-temperature water flows from the heat pump 60 to the high-temperature water tank 61; the flow passages 611 and 612, through which the high-temperature water circulates between the high-temperature water tank 61 and the reactor R; and the flow passage 614 through which the high-temperature water flows from the high-temperature water tank 61 to the heat pump 60 (FIGS. 1 to 3). The flow passages through which the low-temperature water flows include: the flow passage 625 through which the low-temperature water flows from the heat pump 60 to the low-temperature water tank 62; the flow passages 621 and 622 through which the low-temperature water circulates between the low-temperature water tank 62 and the reactor R; and the flow passage 624 through which the low-temperature water flows from the low-temperature water tank 62 to the heat pump 60 (FIGS. 1 to 3).

The heat dissipation portion 70 is provided on the flow passage 614, and the heat dissipation portion 80 is provided on the flow passage 624 (FIG. 3). The DAC apparatus 100 further includes the branch flow passage 626, which guides some amount of the low-temperature water flowing through the flow passage 625 to the flow passage 624, which is disposed upstream the heat dissipation portion 80 (FIG. 3). The vacuum pump 4 is cooled by the low-temperature water flowing through the branch flow passage 626 (FIG. 3). Thus, it becomes possible to sufficiently cool the vacuum pump 4, which is used particularly in a high-load state among the respective units of the DAC apparatus 100, using the low-temperature water having the temperature that has been sufficiently lowered by the heat pump 60. In this case, power consumption necessary for driving the vacuum pump 4 can be suppressed, and in addition, the pump efficiency and CO₂ recovery efficiency of the vacuum pump 4 can be improved. In addition, by cooling the vacuum pump 4 using the branch flow passage 626 of the flow passage 625 from the heat pump 60, it becomes possible to appropriately cool the adsorbent of each reactor R without increasing the temperature of the low-temperature water stored in the low-temperature water tank 62 and circulated into the heat exchanger 6 of each reactor R.

The above embodiment can be combined as desired with one or more of the aforesaid modifications. The modifications can also be combined with one another.

According to the present invention, it becomes possible to appropriately cool each unit of the DAC apparatus.

Above, while the present invention has been described with reference to the preferred embodiments thereof, it will be understood, by those skilled in the art, that various changes and modifications may be made thereto without departing from the scope of the appended claims.

1. A DAC apparatus configured to recover CO₂ in the atmosphere, comprising:
a heat pump configured to transfer heat from a low-temperature heat medium to a high-temperature heat medium to raise a temperature of the high-temperature heat medium to a target temperature, the low-temperature heat medium cooling an adsorbent for adsorbing or absorbing CO₂, the high-temperature heat medium heating the adsorbent;
a high-temperature-side heat exchanger provided on a high-temperature-side flow passage through which the high-temperature heat medium flows and configured to cool the high-temperature heat medium through heat exchange with outside air;
a high-temperature-side control valve provided on the high-temperature-side flow passage and configured to switch whether to pass through or bypass the high-temperature-side heat exchanger; and
a controller configured to control the high-temperature-side control valve, wherein
the controller controls the high-temperature-side control valve to pass through the high-temperature-side heat exchanger when a temperature of the low-temperature heat medium is equal to or higher than a predetermined temperature.

2. The DAC apparatus according to claim 1, further comprising:
a low-temperature-side heat exchanger provided on a low-temperature-side flow passage through which the low-temperature heat medium flows and configured to cool the low-temperature heat medium through heat exchange with outside air; and
a low-temperature-side control valve provided on the low-temperature-side flow passage and configured to switch whether to pass through or bypass the low-temperature-side heat exchanger, wherein
the controller further controls the low-temperature-side control valve and the high-temperature-side control valve to bypass the low-temperature-side heat exchanger and the high-temperature-side heat exchanger when the temperature of the low-temperature heat medium is lower than a first temperature, to pass through the low-temperature-side heat exchanger and bypass the high-temperature-side heat exchanger when the temperature of the low-temperature heat medium is equal to or higher than the first temperature and is lower than a second temperature, and to pass through the low-temperature-side heat exchanger and the high-temperature-side heat exchanger when the temperature of the low-temperature heat medium is equal to or higher than the second temperature.

3. The DAC apparatus according to claim 2, wherein
the controller further stops operation of the DAC apparatus when the temperature of the low-temperature heat medium is equal to or higher than a third temperature set higher than the second temperature.

4. The DAC apparatus according to claim 1, further comprising:
a vacuum pump connected through vacuum piping with an adsorption chamber provided with the adsorbent and configured to suck desorption gas from the adsorbent, wherein
the low-temperature heat medium further cools the vacuum pump.

5. The DAC apparatus according to claim 4, further comprising:
a high-temperature heat medium tank configured to store the high-temperature heat medium; and
a low-temperature heat medium tank configured to store the low-temperature heat medium, wherein
the high-temperature-side flow passage includes:
a high-temperature-side outlet flow passage through which the high-temperature heat medium flows from the heat pump to the high-temperature heat medium tank;
a high-temperature-side circulation flow passage through which the high-temperature heat medium circulates between the high-temperature heat medium tank and the adsorption chamber; and
a high-temperature-side inlet flow passage through which the high-temperature heat medium flows from the high-temperature heat medium tank to the heat pump, wherein
a low-temperature-side flow passage through which the low-temperature heat medium flows includes:
a low-temperature-side outlet flow passage through which the low-temperature heat medium flows from the heat pump to the low-temperature heat medium tank;
a low-temperature-side circulation flow passage through which the low-temperature heat medium circulates between the low-temperature heat medium tank and the adsorption chamber; and
a low-temperature-side inlet flow passage through which the low-temperature heat medium flows from the low-temperature heat medium tank to the heat pump, wherein
the high-temperature-side heat exchanger is provided on the high-temperature-side inlet flow passage, wherein
a low-temperature-side heat exchanger configured to cool the low-temperature heat medium is provided on the low-temperature-side inlet flow passage, wherein
the DAC apparatus further comprises:
a branch flow passage configured to guide some amount of the low-temperature heat medium flowing through the low-temperature-side outlet flow passage to the low-temperature-side inlet flow passage disposed upstream of the low-temperature-side heat exchanger, wherein
the vacuum pump is cooled by the low-temperature heat medium flowing through the branch flow passage.
